(19) United States
(12) Patent Application Publication
(10) Pub. No.: US 2025/0371394 A1
(43) Pub. Date: Dec. 4, 2025

(54) ORCHESTRATION-ORIENTED ESTIMATION OF QUANTUM STATE DISTRIBUTIONS

(71) Applicant: Dell Products L.P., Round Rock, TX (US)

(72) Inventors: Rômulo Teixeira de Abreu Pinho, Niterói (BR); Miguel Paredes Quiñones, Campinas (BR); João Victor Da Fonseca Pinto, Rio de Janeiro (BR); Micael Veríssimo de Araújo, Rio de Janeiro (BR)

(21) Appl. No.: 18/677,301

(22) Filed: May 29, 2024

(51) Int. Cl. G06N 10/20

(52) U.S. Cl. CPC G06N 10/20

(57) ABSTRACT

Automatic shot determination for quantum circuit execution is disclosed. An orchestration engine receives, as input, a quantum job and constraints. Shots of the quantum circuit included in the quantum job are performed in an iterative manner. After each iteration, the probability distribution is evaluated in light of the constraints. If the constraints are violated, the quantum job is terminated. Otherwise, execution continues at least until an uncertainty requirement is satisfied. This allows the number of shots to be determined on the fly rather than specified by a developer.

### TECHNOLOGICAL FIELD OF THE DISCLOSURE

Embodiments disclosed herein generally relate to quantum jobs and to orchestrating the execution of quantum jobs. More particularly, at least some embodiments relate to systems, hardware, software, computer-readable media, and methods for automating estimating quantum state distributions and/or automatically performing a reduced or minimum number of shots during execution of the quantum job.

### BACKGROUND

Quantum computing systems, whether physical, virtual, or simulated, are capable of solving problems whose complexity grows exponentially with the size of the input. When solving such a problem, the problem is often expressed as a quantum circuit, which corresponds to a quantum algorithm and is a form of universal quantum computing.

Quantum circuits contain a set of instructions (or gates) that manipulate quantum states. Quantum states correspond to some state of interaction between quantum bits, or qubits, which are the basic unit of information in quantum computing systems. The qubits, in turn, represent the information that is processed by the quantum circuit. Once the quantum circuit is prepared, the quantum circuit is executed in the quantum system. Quantum systems are probabilistic in nature. In order to obtain a stable solution to the QUBO, it is typically necessary to execute the quantum circuit multiple times. Each execution is referred to, in one example, as a shot.

Quantum circuits are inherently stochastic for various reasons. For example, quantum systems are not deterministic, according to the laws of quantum physics. Quantum systems have inherent noise that can impact the execution of the quantum circuit. As a result, obtaining a stable result of a quantum circuit requires multiple shots. The result of the quantum circuit is based on statistics of the ensembles of outcomes generated in each shot.

The outcome of gate-based quantum circuits typically includes the probability, or amplitude, of the expected quantum states obtained via measurement operations. Each measurement yields one quantum state, which is affected by both the configuration of the quantum circuit as well as by the noise present in the quantum system. Each shot is, in effect, equivalent to sampling from the (unknown) state distribution and obtaining one state. In the limit, and according to the law of large numbers, sampling infinitely many times would reveal the expected distribution of states. In practice, an approximation of this distribution can be determined after a finite number of shots.

Unfortunately, performing large number of shots of the quantum circuit is often impractical. As a result, a developer may determine a fixed number of shots in the hope that the distribution obtained from running the fixed number of shots is close to the expected distribution. However, due to at least noise in the quantum system, the appropriate number shots cannot be known in advance. This often results in a cyclic trial-and-error driven approach when developing quantum circuits. An iterative cycle of running a large number of shots and refining the circuits based on the results may be performed. When a large number of shots are performed, this cycle can quickly become prohibitive in terms of at least time and cost.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a quantum algorithm or circuit configured for execution in a quantum system;

FIG. 2 discloses aspects of geometrically interpreting a quantum state;

FIG. 3 discloses aspects of an evolving probability distribution as the number of shots increases;

FIG. 4 discloses aspects of an example orchestration engine configured to orchestrate the execution of a quantum job in a manner that reduces or minimizes the number of shots required to achieve a sufficient estimated state probability;

FIG. 5 discloses aspects of collecting a dataset for training a model to predict an estimated state probability;

FIG. 6 discloses aspects of prediction uncertainties at various times;

FIG. 7 discloses aspects of orchestrating a quantum job; and

FIG. 8 discloses aspects of a computing device, system, or entity.

### DETAILED DESCRIPTION OF SOME EXAMPLE EMBODIMENTS

Embodiments disclosed herein generally relate to quantum circuits (algorithms) and executing quantum circuits in quantum systems. More particularly, at least some embodiments relate to systems, hardware, software, computer-readable media, and methods for orchestrating the execution of quantum circuits and determining, automatically and dynamically, a number of shots to be performed to achieve an acceptable result.

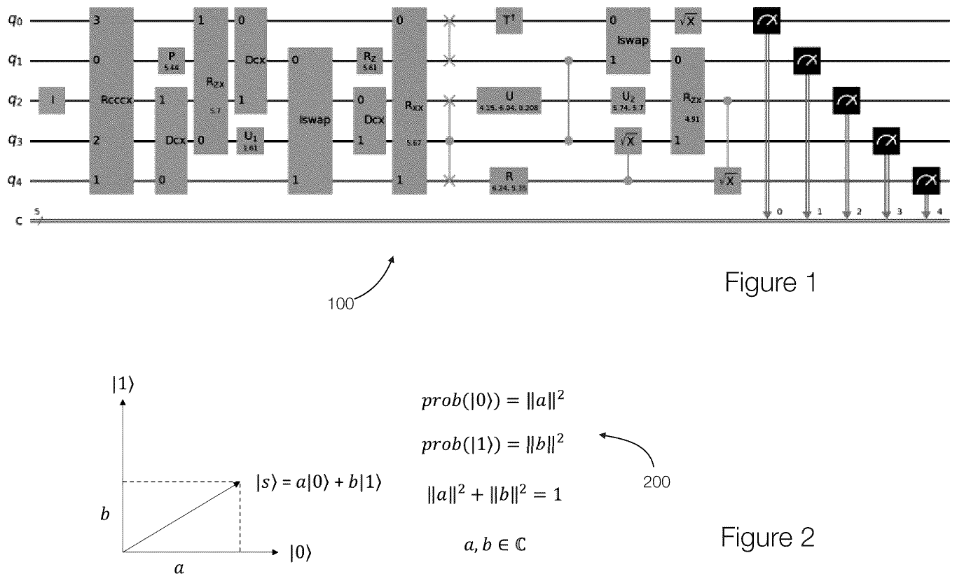

FIG. 1 discloses aspects of a quantum circuit configured for execution in a quantum system. A circuit 100 illustrates or contains a set of instructions (gates) that manipulate quantum states. Quantum states correspond to a state of interaction between quantum bits or qubits, which are a basic unit of information in quantum computing systems. The example circuit 100 includes interactions related to 5 qubits. The size of a quantum circuit may be reflected in the number of qubits, which can be much larger than 5.

Generally, qubits are the mathematical equivalent of vectors in a complex geometric space. In a quantum algorithm, qubits form a vectorial basis with 2ⁿ components, where n is the number of qubits used in the algorithm. Linear combinations of the components of the vectorial basis form the referred quantum states.

A special instruction in the execution of quantum circuits is the measurement operation, which allows algorithm developers to obtain the results of the quantum circuit execution. The measurement is a projection of the final quantum state vector, at the end of the quantum circuit execution, onto one component of the basis. In other words, a state collapses onto one of the components of the vectorial basis.

FIG. 2 discloses aspects of geometrically interpreting a quantum system. Following the rules of quantum physics, a state collapse via a measurement operation is probabilistic, and the probability of a state collapsing onto one of the components of the basis is equal to the square of the magnitude of the (complex) amplitude of the state along that component, as illustrated in the graph 200 shown in FIG. 2.

More specifically, the graph 200 is a geometrical interpretation of a quantum system with one qubit forming a vectorial basis with two components (|0 [symbol] and |1 [symbol] ). The quantum state |s [symbol] is a linear combination (or superposition) between the components of the basis.

In practice, and following the rules of quantum physics, a state vector |s [symbol] cannot be obtained directly. Each run of the quantum circuit, a shot, collapses onto one of the basis states via a measurement operation. After several shots, an estimate of the probability distribution that corresponds to the magnitude of the components of |s [symbol] in the vectorial basis can be determined. More specifically, as the quantum circuit is repeatedly executed, the probability distribution evolves towards a stable configuration. The components of |s [symbol] can be derived from the stable configuration of the probability distribution.

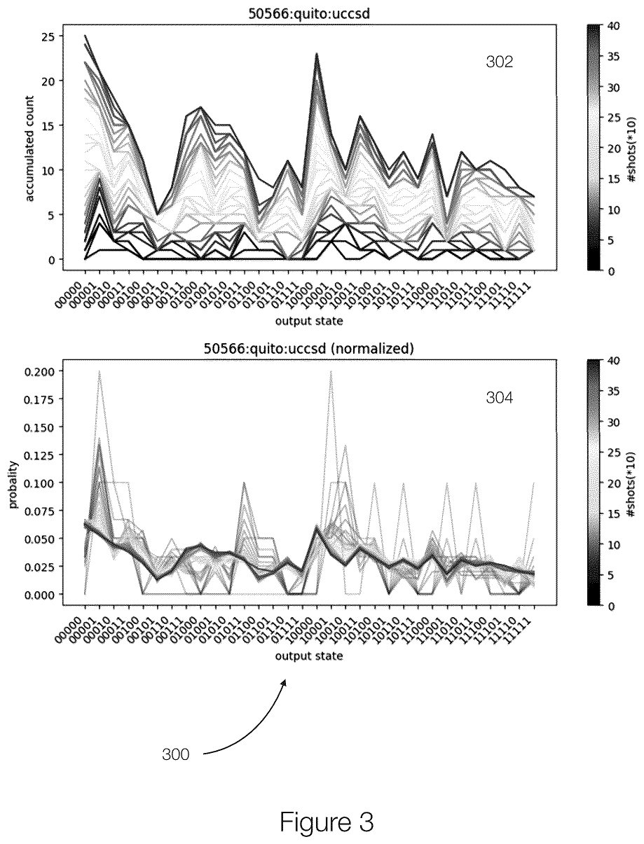

FIG. 3 discloses aspects of a probability distribution that evolves as the number of executions or shots increases. In this example, the probability distribution of the output states is typically obtained by counting the number of times |s [symbol] collapses onto each component of the basis and then normalizing the counts to sum to 1. The graphs 300 represent the evolution of the probability distribution for an example quantum algorithm as the number of shots increases to 400. This example includes an algorithm with 5 qubits such that the vectorial basis has 2⁵=32 components. The graph 302 illustrates the accumulated count of the number of times each basis component was measured at the output. The graph 304 represents normalized counts forming a probability distribution. In this example the distribution evolves to a stable configuration as the number of shots increases.

Each run (or shot) of the quantum circuit or algorithm is equivalent to sampling from the (unknown) state distribution and obtaining one element of the basis. In the limit, and according to the law of large numbers, sampling infinitely many times would reveal the expected distribution of components. In practice, an approximation of the probability distribution is sought after by running a finite (but large) number of shots.

As previously stated, running the circuit many times may be impractical. Thus, developers conventionally determine a fixed number of shots in the hope that the distribution obtained from the determined fixed number of shots is close to the expected probability distribution. However, quantum systems suffer with noise interference, which can deteriorate the results of the quantum circuit executions. To overcome the impact of noise the required number of shots must be larger.

Unfortunately, the required or shots needed to obtain a suitable probability distribution cannot be determined in advance. As a result, developers usually employ a cyclic trial-and-error approach of developing circuits, running the circuits with a large number of shots, refining the circuits based on the obtained results, and running the circuits again. With a large number of shots, this cycle can quickly become prohibitive from at least computational, time, and cost perspectives.

Embodiments of the invention relate to orchestrating quantum jobs such that a developer does not need to specify or determine the number of shots required to achieve or yield acceptable results. Advantageously, embodiments of the invention also orchestrate quantum jobs such that the execution of quantum circuits is more efficient by running fewer or as few shots as possible. In one example, the number of shots may be reduced (e.g., from what a developer may specify) in a manner that still satisfies service level objective (SLO) constraints. Further, the developer is relieved of the need to determine the number of shots to be performed.

In one example, an orchestration engine includes a machine learning model configured to infer or predict a circuit's final output (final probability distribution) from intermediary results (intermediary probability distributions). When a quantum job is constrained, the orchestration engine may be configured to automatically determine the required number of shots to remain within the constraints. This allows quality of circuit execution and cost of circuit execution to be balanced. Example constraints may include maximum time to run the circuit, maximum number of shots, maximum cost, acceptable level of uncertainty, or the like or combinations thereof.

In one example, the input to the orchestration engine is a quantum job. The quantum job may include a quantum circuit, a target quantum backend (target quantum computing system selected by a user for executing the quantum circuit), and constraints. The orchestration engine orchestrates the execution of the quantum job by executing the quantum circuit on the target quantum backed for a small, pre-defined set of k shots. After executing the set of k shots, an intermediary probability distribution of the output states is measured or determined.

The measured state distribution, the total number of shots executed to this point, the quantum circuit, and the quantum backend are input to a probability estimator module. The probability estimator module includes a model that uses these inputs to predict the final state probability of the circuit execution along and a second model configured to predict or determine an uncertainty associated with the prediction. The uncertainty associated with the estimated probability distribution is modelled by tracking the performance of the probability estimator module during training.

Finally, the orchestration engine verifies whether the uncertainty is outside the limits (uncertainty constraints). If the uncertainty is outside of the constraints and if the time or cost constraints have not been exceeded, the orchestration engine executes another set of k shots.

This process is repeated until the uncertainty is within the specified limits or constraints, or the cost/time constraints of the execution have been violated. By doing this, the orchestration engine either executes only the required number of shots according to the user's objectives or returns a message indicating that the constraints could not be satisfied.

Embodiments of the invention allow a quantum circuit to be executed in such a way that the developer is relieved from knowing or determining how many shots are required for a given quantum circuit to obtain results at a desired quality. An orchestration engine advantageously performs fewer shots, in an automated manner, to satisfy quality, time, and/or cost constraints. A prediction estimator module estimates a final state distribution given an intermediary state distribution. The uncertainty is modelled during training and used when estimating the uncertainty of the intermediary state distribution.

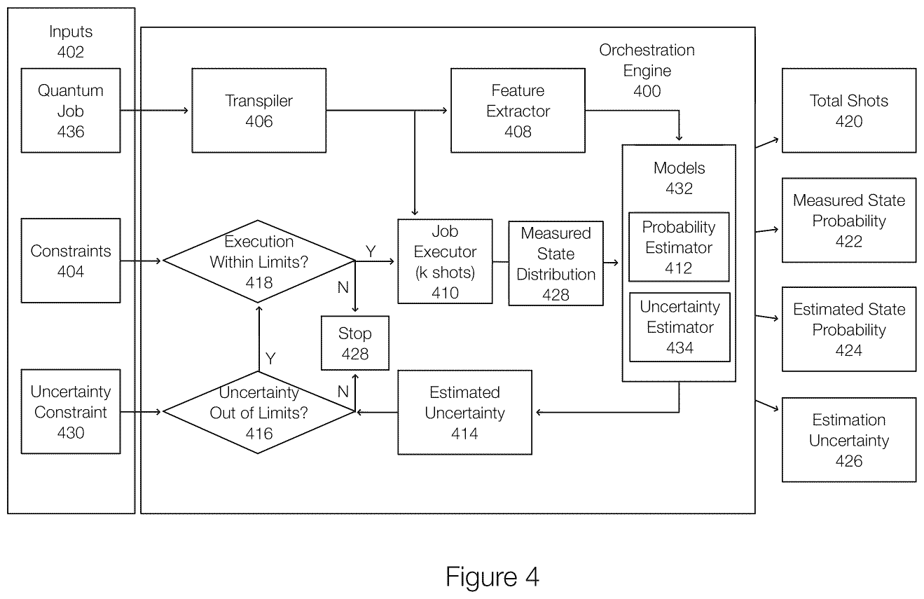

FIG. 4 discloses aspects of an example orchestration engine. Aspects of orchestrating a quantum job, which includes orchestrating the execution of a quantum algorithm or circuit, may be performed by an orchestration engine 400 itself or orchestrated using external resources. The orchestration engine 400 may be viewed as a pipeline that moves a quantum job from reception to execution and result delivery.

The pipeline begins when the orchestration engine 400 receives inputs 402. The inputs 402 may include a quantum job 436. The quantum job 436 may include a quantum backend (target quantum system in which the circuit is to be executed) and a quantum circuit. The constraints 404 are another example of inputs 402 that may be received by the orchestration engine 400. The constraints 404 may include a maximum number of shots and a maximum execution time. An uncertainty constraint 430 may also be provided or included in the inputs 402. The uncertainty constraint 430 identifies an acceptable uncertainty. Once a result is within the uncertainty constraint 430, circuit execution may be stopped and the output may be provided.

The quantum circuit included in the quantum job 436 is typically transpiled by a transpiler 406. Transpiling may include converting the quantum circuit to a form or format that is acceptable for the quantum backend identified in the quantum job 436. This is often performed transparently. However, to ensure compatibility with the probability estimator 412, transpilation by the transpiler 406 is performed separately in one example.

The transpiled circuit and the quantum backend are provided to the job executor 410. The executor 410, which has access to all quantum backends available in the given infrastructure, dispatches the circuit to the selected quantum backend (the quantum system identified in the quantum job 436) and the circuit is executed in the selected quantum backend for a pre-determined number of k shots.

After a set of k shots are executed in the target quantum backend, the executor 410 collects the measured state probability distribution 428 resulting from the set of k shots (e.g., by counting the occurrences of each state and normalizing the occurrences as previously described. Advantageously, the developer is unaware of the number of shots performed or orchestrated by the orchestration engine 400 and of the intermediary outcome collected after the k shots were executed.

The transpiled circuit and the quantum backend are also provided as input to the feature extractor 408. This feature extractor 408 is configured to transform a native representation of the quantum circuit and of the quantum backend into a required presentation for the probability estimator 412, which is an example of a machine learning model trained to generate an estimated state probability. In this manner, characteristics of the quantum circuit and/or of the quantum backed can be provided as input to the models 432 and accounted for in estimating the probability distribution.

The probability estimator 412 thus receives, as input, features generated by the feature extractor 408, which relate to the transpiled quantum circuit and the quantum backend that performed the shots, the total number of shots executed, and the measured state distribution 428. These inputs allow the probability estimator 412 generate or predict an estimated state probability 424.

In one example, the models include an uncertainty estimator 434 that outputs an estimation uncertainty 414 associated with the predicted estimated state probability 424. The total number of shots 420 and measured state probability 422 may also be output or provided.

The uncertainty 414 collected from the uncertainty estimator 434 is assessed against the uncertainty constraint 430 provided by the user. If the estimation uncertainty 414 violates the uncertainty constraints or is outside the limits of the uncertainty constraint 430 (Y at 416) and/or the circuit execution is within limits (Y at 418) of the constraints 404 such as maximum number of shots, maximum execution time, maximum budget, then another set of k shots are performed by the executor 410 in the quantum backend.

The orchestration engine 400 iterates through the pipeline shown in FIG. 4 until the uncertainty 414 satisfies the uncertainty constraint 430, or the time/cost/shot budget, represented by the constraints 404, is exceeded. At this point, the orchestration engine 400 outputs the total shots 420 executed, the measured state probability distribution 422 after those shots, the estimated final state probabilities 424, and the uncertainty 426 associated with the estimation or prediction of the probability estimator 412.

The job executor 410 is configured to execute the transpiled circuit on the identified quantum backend. However, the executor 410 is configured to execute only k shots. The executor 410 is also configured to measure the state probability distribution after each round of k shots. Further, the executor 410 also tracks the total number of shots over n rounds of k shots. In one example, the executor 410 may also track various statistics such as execution time per shot per backend, costs, and the like.

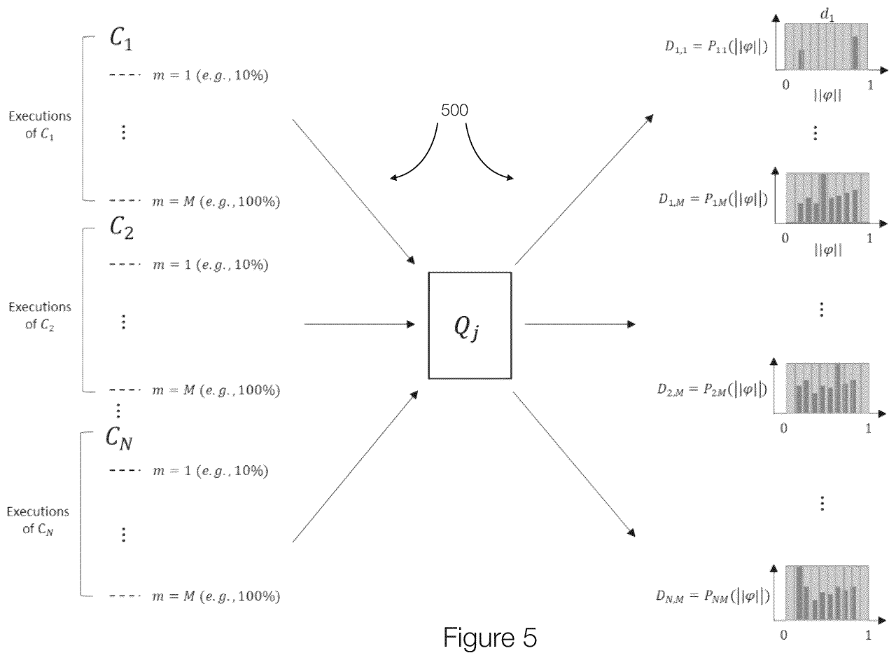

The probability estimator 412 is an example of a machine learning model that is trained on a large dataset of quantum executions of several circuits. FIG. 5 discloses aspects of collecting training data for the probability estimator 412. As illustrated in FIG. 5, the model is trained with data 500 including quantum circuits, Cᵢ, executed on a variety of quantum backends Qⱼ, j ∈ {1, J}, for several shots, M. At several stages, m ∈ {1 . . . M}, during the execution, the state probability distributions, D_{i,m}, at those stages are measured and stored. Each m corresponds to a certain percentage of the execution of the total number of shots and D_{i,M} is the final probability distribution measured at the end of the execution of Cᵢ.

In addition to the executions illustrated in the data 500, features of both the quantum circuit and the quantum backend are extracted. These features, in one example, capture intrinsic relationships between operations on the quantum circuit and physical characteristics of the quantum hardware that may influence the state probabilities being obtained.

Features of Cᵢ may include the number of qubits, the depth, the adjacency matrix with CNOT connections between qubit pairs, and/or the like. Features of Qⱼ may include the adjacency matrix of physical qubit connections, calibration data (e.g., exec time, noise) of those physical qubits, etc. These features are combined into a feature vector, Fᵢⱼ, and incorporated into the training dataset.

In one example, the training dataset will have N*M*J samples containing pairs {x, y} such that x={F_{ij,m}, D_{ij,m}} is the set with features of circuit Cᵢ executed on backend Qⱼ concatenated with the probability distribution D_{ij,m} measured at stage m of the execution and y=D_{ij,M} is the measured final distribution at stage M. A model y= [symbol] _{θ}(x), with parameters θ, is trained so that, at inference time, predictions ŷ= [symbol] _{θ}(x₀) for some unseen x₀ are obtained or generated.

The unseen x₀ corresponds to a tuple, {F_{00,m}, D_{00,m}}, where F_{00,m} is the combination of features of a new circuit, C₀, submitted for execution to backend Q₀, and D_{00,m} is the intermediary probability distribution measure at stage m of the execution of C₀. Note that both C₀ and Q₀ may never have appeared in the training dataset 500. Embodiments of the invention may use generic features of quantum circuits and quantum backends rather than features that directly identify a particular quantum circuit or quantum backend because specific features restrict the prediction power of [symbol] _{θ}. The result ŷ is the predicted final probability distribution for Cᵢ.

Like any machine learning model, the predictions of [symbol] _{θ} have some uncertainty associated with them. In one example, in addition to using the model's predictions, the model's uncertainty is captured and used in orchestrating the quantum job.

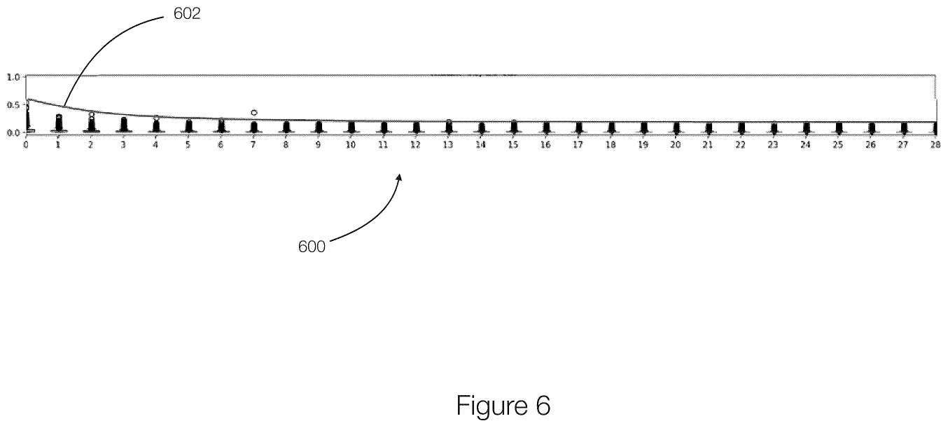

FIG. 6 discloses aspects of prediction uncertainty in a trained probability estimator at various time steps. More specifically, FIG. 6 illustrates the referred uncertainty 600 of a trained model applied to a validation dataset, which includes samples that were not used during training. The validation dataset is similar in structure to the dataset used for training the model. Thus, the validation dataset contains samples x={F_{ij,m}, D_{ij,m}} with circuits running on some backend for M=30 steps (where each step m is an aggregation of approximately k=13 shots). The model used in the experiments that generated the figure predicts the final state distribution, \hat{D}_{i,m}, at step m=M=30 from any previous step during the execution. The graph 600 shows the distribution of prediction errors at each time step. The “prediction error,” in one example, is a metric that indicates how much the final predicted probability distribution is different from the true probability distribution stored the validation dataset.

The line 602 illustrates that the envelope of the errors tends to reduce as m approaches M=30. This is expected, because the closer m gets to M=30, the quantum state distributions tend to be more stable and become more similar to the final distribution measured at the last step and stored in the validation dataset. As a result, it becomes easier for the trained model to estimate the probability distributions from steps that are near the end, and prediction errors tend to become smaller.

The envelope highlighted by the line 602 is a proxy for the uncertainty of the predictions at each step m of the execution of circuit. Embodiments of the invention relate to a model that is configured to estimate the uncertainty at step m.

There are several ways to model this uncertainty. In one example, the data that yielded the envelope as a training dataset is used to obtain a model U_{ϕ}(x, m)→ [symbol] (μ, σ), where [symbol] (μ, σ) represents a Gaussian function with mean μ and standard deviation σ. In other words, U_{ϕ} will be trained to estimate the (Gaussian) distribution of prediction errors of [symbol] _{θ} across the time steps.

To train U_{ϕ}, a dataset with pairs {x, y} is assembled, where x={m}, m={1, . . . , M}, and y= [symbol] (μ, σ) is the distribution of the prediction errors of [symbol] _{θ} at each time step. Thus, U_{ϕ} translates into a regression model to infer [symbol] (μ, σ) as a function of the time step along the execution of a quantum circuit.

Returning to FIG. 4, the probability estimator 412 of the orchestration engine 400 includes a first model [symbol] _{θ} to predict the final probability distribution at a given time step, m, after executing some shots of the quantum circuit and a second model U_{ϕ} (e.g., the uncertainty estimator 434) to infer the uncertainty associated with [symbol] _{θ}'s prediction at the same time step, m. The output of U_{ϕ}(m) is the estimated or predicted mean and standard deviation of the prediction error at step m in one example.

In one example, the uncertainty model U_{ϕ} is trained such that the uncertainty is expressed in terms of μ±σ. In one example, the uncertainty constraint included in the constraints 404 provided by the user may be expressed in the form μ±σ to indicate the acceptable average prediction error obtained from the orchestration engine 400 and the associated variation. In one example, after inferring the uncertainty, the uncertainty estimator 434 passes the estimated uncertainty 414 for evaluation or comparison at 416, which may be performed by an uncertainty checking engine.

The operation in the uncertainty checking engine is performed to determine whether the estimated uncertainty 414 is out of limits. If the inferred [symbol] (μ, σ), after executing a certain number of shots is below the limits in the uncertainty constraint 430, the execution of the circuit may be stopped 428. As described earlier, the orchestration engine 400 returns to the user the total number of shots executed 420, the measured state probabilities 422 after those shots, the predicted final state probabilities 424, and the inferred uncertainty 426 of the prediction.

If the inferred uncertainty 414 is still above (Y at 416) the uncertainty constraint 430, the orchestration engine 404 may continue with executing the circuit k more shots. This may depend on the other constraints 404.

In one example, other constraints 404 may include maximal time and maximal cost. Both of these constraints depend on the target quantum backend for executing the circuit as each quantum backend has characteristics and capabilities that influence time and cost.

As previously stated, the executor 410 may track statistics regarding quantum backends that are available to the orchestration engine 400. A constraint engine configured to determine whether time and/or budget constraints are within limits may retrieve, from the executor 410, the total time taken so far and the number of total shots of the quantum circuit that have been performed. This information is used to determine or estimate the time needed to execute an additional k shots. Thus, the time needed for a next iteration of shots is based on the statistics of execution time (e.g., time per shot) in one example.

Budget constraints may be checked in a similar manner. The constraint engine estimates or determines the total estimated cost of running a new round or set of k shots. If the estimated total time and cost including the new k shots are below the maximal values given by the user in the constraints 404 or (Y at 418), the orchestration engine 400 will execute another round of k shots and obtain a new estimated state (e.g., final) probability 424 and a new estimated uncertainty 414.

Because the constraints 404 (e.g., time/budget) are known, the executor 410 can determine how many shots, in total, of the quantum circuit can be executed. The parameter k may be determined to be a fixed fraction of the total allowed shots (e.g., 5%). This also makes training the models [symbol] _{θ} (to predict the state probabilities) and U_{ϕ} (to infer the uncertainty of [symbol] _{θ}) more general, because the time steps m can be transformed into percentage of completion of the execution and M=100%. Therefore, the models can be trained with such percentages of completion instead of the nominal number of steps.

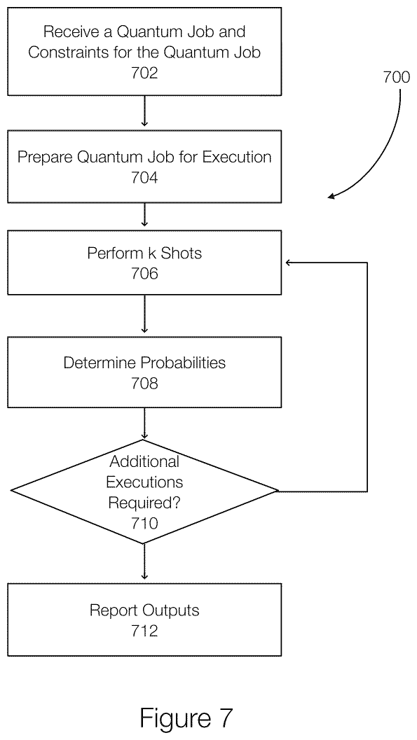

FIG. 7 discloses aspects of a method for orchestrating a quantum job. The method 700 includes receiving 702 a quantum job and/or constraints related to the execution of the quantum job. The constraints may relate to time, cost, uncertainty, shots, or the like. Once received, the quantum job is prepared 704 for execution and k shots are performed 706 is a quantum backend identified in the received quantum job.

After the k shots are executed, embodiments of the invention may determine 710 whether additional executions are required. More specifically, a measured state distribution is obtained based on the k shots. The final estimated probability distribution is estimated along with an uncertainty in the final estimated probability distribution. If the uncertainty is outside of the constraints and if the other constraints permit, another cycle is performed and initiated by performing another set of k shots. The process of estimating the final probability distribution and an uncertainty are performed. If necessary (Y at 710), this process repeats.

More specifically, this process repeats until the uncertainty is below the relevant constraint and/or cost/time will be exceeded. If further shots are not required or constraints are violated (N at 710), the output is reported 712.

This allows the number of shots to dynamically adapt to the uncertainty in the prediction. If a prediction is close enough (uncertainty is within limits), circuit execution can be terminated. This allows a suitable probability distribution to be determined without requiring the number of shots to be specified in advance and without requiring a developer to spend time determining the number of shots to be performed. Rather, the quality of the result can be balanced with time and/or cost budgets.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, quantum circuit related operations, probability distribution related operations, quantum circuit (shot) operations, constraint determination operations, automatic shot determination operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.
Embodiment 1. A method for orchestrating a quantum job, the method comprising: receiving input into an orchestration engine, the input including a quantum job and constraints associated with the quantum job, the constraints including an uncertainty constraint and budget constraints, performing one or more iterations until the uncertainty constraint is within limits or the budget constraints are outside of limits, wherein each iteration includes, performing k shots of a quantum circuit included in the quantum job in a quantum backend identified in the quantum job, measuring a state probability distribution of the quantum circuit after performing the k shots, estimating a final state probability distribution of the quantum circuit based on the measured state probability distribution, and determining an estimated uncertainty of the estimated final state probability distribution, wherein the final state probability distribution, predicted from the measured state probability distribution, is output when the uncertainty is within limits along with the estimated uncertainty.
Embodiment 2. The method of embodiment 1, wherein the budget constraints include a maximal time constraint and a maximal cost constraint.
Embodiment 3. The method of embodiment 1 and/or 2, further comprising evaluating the constraints after each of the iterations, wherein the budget constraints are evaluated as if a next iteration was already performed.
Embodiment 4. The method of embodiment 1, 2, and/or 3, wherein the k shots is a percentage of total shots, wherein the total shots is based on the budget constraints and the quantum backend.
Embodiment 5. The method of embodiment 1, 2, 3, and/or 4, further comprising outputting actual shots executed during the one or more iterations.
Embodiment 6. The method of embodiment 1, 2, 3, 4, and/or 5, further comprising outputting the measured state probability distribution.
Embodiment 7. The method of embodiment 1, 2, 3, 4, 5, and/or 6, wherein the uncertainty constraint is expressed in terms of mean and standard deviation.
Embodiment 8. The method of embodiment 1, 2, 3, 4, 5, 6, and/or 7, wherein the final state probability distribution is estimated by a probability estimator that has been trained on training data including the executions of multiple quantum circuits in multiple quantum backends at various stages of executions.
Embodiment 9. The method of embodiment 1, 2, 3, 4, 5, 6, 7, and/or 8, wherein the estimated uncertainty is estimated by an uncertainty estimator trained using a dataset that is associated with uncertainties at various time steps.
Embodiment 10. A method for orchestrating a quantum job, the method comprising: receiving a quantum job and constraints for the quantum job, preparing a quantum circuit included in the quantum job for execution, performing k shots in a quantum backend identified in the quantum job, determining whether additional shots are required based on a measured probability distribution, a predicted final probability distribution, and an estimated uncertainty, and outputting a result that includes the measured probability distribution, the predicted final probability distribution, and the estimated uncertainty when the estimated uncertainty is below an uncertainty constraint.
Embodiment 11. The method of embodiment 10, wherein iterations of k shots are repeated until the estimated uncertainty is below the uncertainty constraint or other constraints including at least one of a time constraint or a cost constraint are outside of limits.
Embodiment 12. A system, comprising hardware and/or software, operable to perform any of the operations, methods, or processes, or any portion of any of these, disclosed herein.
Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

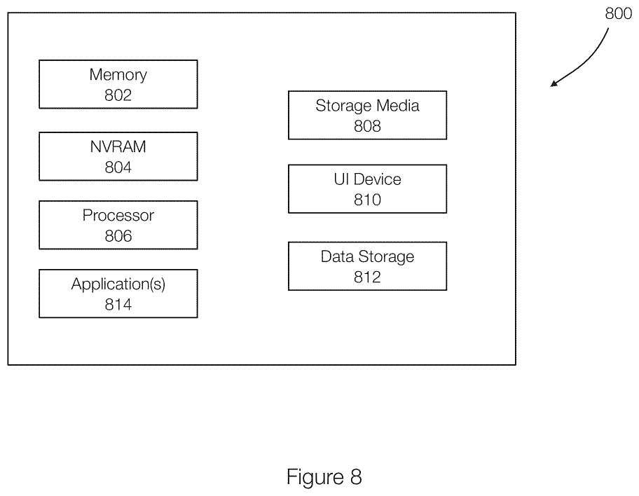

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for orchestrating a quantum job, the method comprising:
receiving input into an orchestration engine, the input including a quantum job and constraints associated with the quantum job, the constraints including an uncertainty constraint and budget constraints;
performing one or more iterations until the uncertainty constraint is within limits or the budget constraints are outside of limits, wherein each iteration includes;
performing k shots of a quantum circuit included in the quantum job in a quantum backend identified in the quantum job;
measuring a state probability distribution of the quantum circuit after performing the k shots;
estimating a final state probability distribution of the quantum circuit based on the measured state probability distribution; and
determining an estimated uncertainty of the estimated final state probability distribution;
wherein the final state probability distribution, predicted from the measured state probability distribution, is output when the uncertainty is within limits along with the estimated uncertainty.

2. The method of claim 1, wherein the budget constraints include a maximal time constraint and a maximal cost constraint.

3. The method of claim 2, further comprising evaluating the constraints after each of the iterations, wherein the budget constraints are evaluated as if a next iteration was already performed.

4. The method of claim 1, wherein the k shots is a percentage of total shots, wherein the total shots is based on the budget constraints and the quantum backend.

5. The method of claim 1, further comprising outputting actual shots executed during the one or more iterations.

6. The method of claim 4, further comprising outputting the measured state probability distribution.

7. The method of claim 1, wherein the uncertainty constraint is expressed in terms of mean and standard deviation.

8. The method of claim 1, wherein the final state probability distribution is estimated by a probability estimator that has been trained on training data including the executions of multiple quantum circuits in multiple quantum backends at various stages of executions.

9. The method of claim 1, wherein the estimated uncertainty is estimated by an uncertainty estimator trained using a dataset that is associated with uncertainties at various time steps.

10. A non-transitory storage medium having stored therein instructions that are executable by one or more hardware processors to perform operations for orchestrating a quantum job, the operations comprising:
receiving input into an orchestration engine, the input including a quantum job and constraints associated with the quantum job, the constraints including an uncertainty constraint and budget constraints;
performing one or more iterations until the uncertainty constraint is within limits or the budget constraints are outside of limits, wherein each iteration includes;
performing k shots of a quantum circuit included in the quantum job in a quantum backend identified in the quantum job;
measuring a state probability distribution of the quantum circuit after performing the k shots;
estimating a final state probability distribution of the quantum circuit based on the measured state probability distribution; and
determining an estimated uncertainty of the estimated final state probability distribution;
wherein the final state probability distribution, predicted from the measured state probability distribution, is output when the uncertainty is within limits along with the estimated uncertainty.

11. The non-transitory storage medium of claim 10, wherein the budget constraints include a maximal time constraint and a maximal cost constraint.

12. The non-transitory storage medium of claim 11, further comprising evaluating the constraints after each of the iterations, wherein the budget constraints are evaluated as if a next iteration was already performed.

13. The non-transitory storage medium of claim 10, wherein the k shots is a percentage of total shots, wherein the total shots is based on the budget constraints and the quantum backend.

14. The non-transitory storage medium of claim 10, further comprising outputting actual shots executed during the one or more iterations.

15. The non-transitory storage medium of claim 14, further comprising outputting the measured state probability distribution.

16. The non-transitory storage medium of claim 10, wherein the uncertainty constraint is expressed in terms of mean and standard deviation.

17. The non-transitory storage medium of claim 10, wherein the final state probability distribution is estimated by a probability estimator that has been trained on training data including the executions of multiple quantum circuits in multiple quantum backends at various stages of executions.

18. The non-transitory storage medium of claim 10, wherein the estimated uncertainty is estimated by an uncertainty estimator trained using a dataset that is associated with uncertainties at various time steps.

19. A method for orchestrating a quantum job, the method comprising:
receiving a quantum job and constraints for the quantum job;
preparing a quantum circuit included in the quantum job for execution;
performing k shots in a quantum backend identified in the quantum job;
determining whether additional shots are required based on a measured probability distribution, a predicted final probability distribution, and an estimated uncertainty; and
outputting a result that includes the measured probability distribution, the predicted final probability distribution, and the estimated uncertainty when the estimated uncertainty is below an uncertainty constraint.

20. The method of claim 19, wherein iterations of k shots are repeated until the estimated uncertainty is below the uncertainty constraint or other constraints including at least one of a time constraint or a cost constraint are outside of limits.
